(19) United States
(12) Patent Application Publication
(10) Pub. No.: US 2018/0185904 A1
(43) Pub. Date: Jul. 5, 2018

(54) JOINING METHOD OF ULTRA HIGH-STRENGTH STEEL AND NON-STEEL MATERIAL THROUGH TAILORED SOFTENING HEAT TREATMENT USING LASER

(71) Applicants: Hyundai Motor Company, Seoul (KR); Kia Motors Corporation, Seoul (KR)

(72) Inventors: Jun Ho Jang, Yongin-si (KR); Shin Hu CHO, Suwon-si (KR); Jong Kook LEE, Suwon-si (KR)

(73) Assignees: Hyundai Motor Company, Seoul (KR); Kia Motors Corporation, Seoul (KR)

(21) Appl. No.: 15/811,367

(22) Filed: Nov. 13, 2017

(30) Foreign Application Priority Data
Dec. 29, 2016 (KR) 10-2016-0181896

(51) Int. Cl. B21J 15/08; F16B 19/00; B23K 26/00; B21J 15/02

(52) U.S. Cl. CPC B21J 15/08; B21J 15/025; B23K 26/0093; F16B 19/004

(57) ABSTRACT

A method of joining of a ultra high-strength steel and a non-steel material through tailored softening heat treatment using a laser, may include forming a tempering portion by performing heat treatment on a lower plate formed of ultra high-strength steel using the laser; stacking an upper plate formed of a non-steel material on the lower plate formed of the ultra high-strength steel; disposing a connection member on the upper plate; and applying force to the connection member to cause the connection member to pass through the upper plate and then to be inserted into the tempering portion of the lower plate to combine the upper plate and the lower plate.

### CROSS-REFERENCE TO RELATED APPLICATION

The present application claims priority to Korean Patent Application No. 10-2016-0181896 filed on Dec. 29, 2016, the entire contents of which is incorporated herein for all purposes by this reference.

### BACKGROUND OF THE INVENTION

### Field of the Invention

The present invention relates to a mechanical method of joining of ultra high-strength steel and a non-steel material. More particularly, the present invention relates to a method in which ultra high-strength steel is softened by radiating a laser thereto and is then connected to a non-steel material using a connection member.

### Description of Related Art

In the automobile industry, to improve fuel efficiency, which contributes to dealing with environmental problems, weight reduction of vehicle bodies with the use of lightweight materials e.g., aluminum alloys and plastics has been promoted. For the present purpose, a joining method, which may substitute for spot welding generally employed to assemble a vehicle body, is being considered now.

To satisfy such trends, a mechanical joining method using a self-piercing rivet (SPR) is on the rise. Differently from a conventional riveting method in which rivet joining holes are formed on targets to be joined, such as metal plates, a rivet is inserted into the holes and a head portion is formed to join the targets to be joined, in the SPR method, a rivet is press-fitted into targets to be joined by hydraulic pressure or pneumatic pressure without formation of holes on targets to be joined and is plastically deformed, joining the targets to be joined. Therefore, the SPR method is frequently employed recently in the automobile industry.

However, as ultra high-strength steel having high strength and low elongation is used as a vehicle body now, it may be difficult or impossible to sufficiently join ultra high-strength steel and a non-steel material using the SPR method. Therefore, there are attempts to apply other joining methods including a blind rivet method, a resistance element welding, etc.

However, these joining methods require overall change of equipment, which is prepared now, and have a high level of process difficulty, as compared to the SPR method.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method of joining of a ultra high-strength steel and a non-steel material which may improve fastening strength of a self-piercing rivet.

Various aspects of the present invention are directed to providing a method of joining of a ultra high-strength steel and a non-steel material which may improve a product quality and fastening strength without a great change in conventional equipment and design.

Various aspects of the present invention are directed to providing a method of joining of a ultra high-strength steel and a non-steel material through tailored softening heat treatment using a laser, including forming a tempering portion by performing heat treatment on a lower plate formed of the ultra high-strength steel using the laser, stacking an upper plate formed of the non-steel material on the lower plate formed of the ultra high-strength steel, disposing a connection member on the upper plate, and applying force to the connection member to cause the connection member to pass through the upper plate and then to be inserted into the tempering portion of the lower plate to combine the upper plate and the lower plate.

In an exemplary embodiment of the present invention, the ultra high-strength steel may be steel having tensile strength of 980 MPa or more, steel having tensile strength of 1180 MPa or more, or steel having tensile strength of 1470 MPa or more.

In another exemplary embodiment of the present invention, the non-steel material may be carbon fiber reinforced plastic (CFRP) or aluminum.

In still another exemplary embodiment of the present invention, the tempering portion may be formed by performing heat treatment on the lower plate using the laser so that a maximum temperature reaches 400° C. to 550° C., and the laser may be radiated under conditions (1) to (4) below,

a laser generator output of 2.5 kW to 3.5 kW;

a laser generator set temperature of 400° C. to 600° C.;

a laser radiation time of less than 1 second; and

a laser beam focal spot size of 8 mm to 20 mm.

In yet another exemplary embodiment, hardness of the tempering portion may be 270 HV to 350 HV.

In still yet another exemplary embodiment, the connection member may be a self-piercing rivet (SPR).

Other aspects and exemplary embodiments of the invention are discussed infra.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of a self-piercing rivet;

FIG. 2 is a view illustrating a self-piercing rivet apparatus and a process of joining an upper plate and a lower plate using a self-piercing rivet;

FIG. 3 is a cross-sectional view of a joining structure of the upper plate and the lower plate using the self-piercing rivet;

FIG. 4A is a photograph illustrating the cross-section of a joining structure of carbon fiber reinforced plastic (an upper plate) and ultra high-strength steel (a lower plate) having tensile strength of 980 MPa using a self-piercing rivet (SPR) under the condition that tailored softening heat treatment of the lower plate is not conducted;

FIG. 4B is a photograph illustrating the cross-section of a joining structure of carbon fiber reinforced plastic (an upper plate) and ultra high-strength steel (a lower plate) having tensile strength of 1470 MPa using a self-piercing rivet (SPR) under the condition that tailored softening heat treatment of the lower plate is not conducted;

FIG. 5 is a graph illustrating a result of measurement of temperature (heat) applied to a tempering part, when a laser is radiated to ultra high-strength steel having tensile strength of 980 MPa;

FIG. 6 is a graph illustrating a result of measurement of temperature (heat) applied to a tempering part, when a laser is radiated to ultra high-strength steel having tensile strength of 1180 MPa;

FIG. 7 is a graph illustrating a result of measurement of temperature (heat) applied to a tempering part, when a laser is radiated to ultra high-strength steel having tensile strength of 1470 MPa;

FIGS. 8A and 8B are graphs illustrating a result of measurement of hardness when heat treatment using a laser (laser radiation) is conducted for about 1 second on ultra high-strength steel having tensile strength of 980 MPa;

FIG. 9 is a reference view illustrating positions of a lower plate, on which heat treatment was finished, from a central portion thereof for heat treatment to a portion thereof distanced from the central portion by 25 mm in the rightward direction, where hardness is measured;

FIG. 10 is a graph illustrating a result of measurement of hardness when heat treatment using a laser (laser radiation) is conducted for about 1 second on ultra high-strength steel having tensile strength of 1180 MPa;

FIG. 11A and FIG. 11B are graphs illustrating a result of measurement of hardness when heat treatment using a laser (laser radiation) is conducted for about 1 second on ultra high-strength steel having tensile strength of 1470 MPa;

FIG. 12A, FIG. 12B and FIG. 12C are photographs of the cross-section and appearance of a joining structure of different materials of Test Example 1;

FIG. 13A, FIG. 13B and FIG. 13C are photographs of the cross-section and appearance of a joining structure of different materials of Test Example 2; and

FIG. 14A, FIG. 14B and FIG. 14C are photographs of the cross-section and appearance of a joining structure of different materials of Test Example 3.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents and other embodiments within the spirit and scope of the invention as defined by the appended claims.

In the following description of the present invention, a detailed description of known functions and configurations incorporated herein will be omitted when it may make the subject matter of the present invention rather unclear. In the following description of the embodiments, the term “including” will be interpreted as indicating the presence of other elements, unless stated otherwise, and does not exclude presence of the corresponding elements.

Various aspects of the present invention are directed to providing a method of joining a lower plate formed of ultra high-strength steel and an upper plate formed of a non-steel material using a connection member.

Ultra high-strength steel may be a steel material having high strength and low elongation and steel having tensile strength of 980 MPa or more, steel having tensile strength of 1180 MPa or more, or steel having tensile strength of 1470 MPa or more.

As the tensile strength of ultra high-strength steel increases, ultra high-strength steel has increased hardness and increased weight and, when the ultra high-strength steel is applied to means of transportation including a vehicle, fuel efficiency may be lowered. Therefore, as the ultra high-strength steel, steel having tensile strength of 980 MPa to 1470 MPa may be used.

The non-steel material may be carbon fiber reinforced plastic (CFRP) or aluminum.

Although the thicknesses of the lower plate and the upper plate are not limited to specific values, the thicknesses of the lower plate and the upper plate may be 1.0 mm or more, particularly 1.2 mm or more, and more particularly 1.5 mm or more, and be 3.0 mm or less, particularly 2.5 mm or less, and more particularly 2.0 mm or less, respectively.

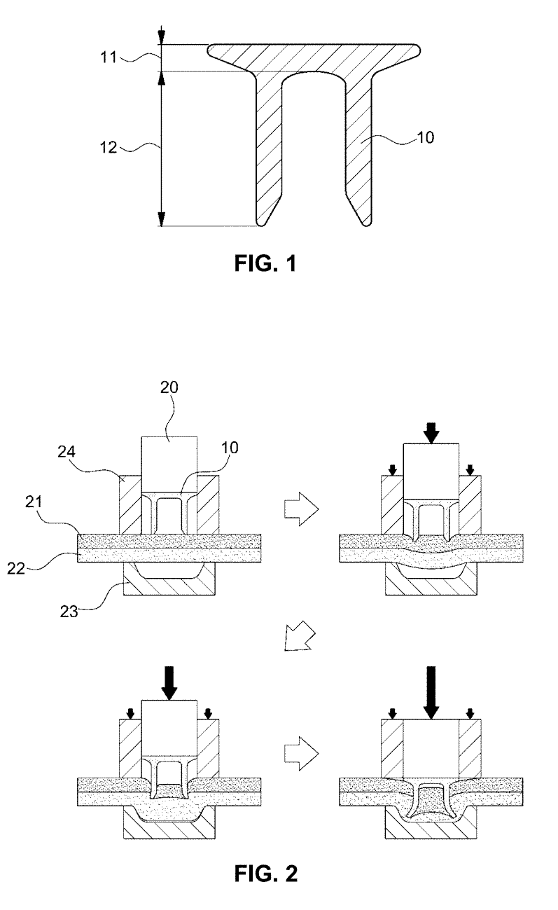

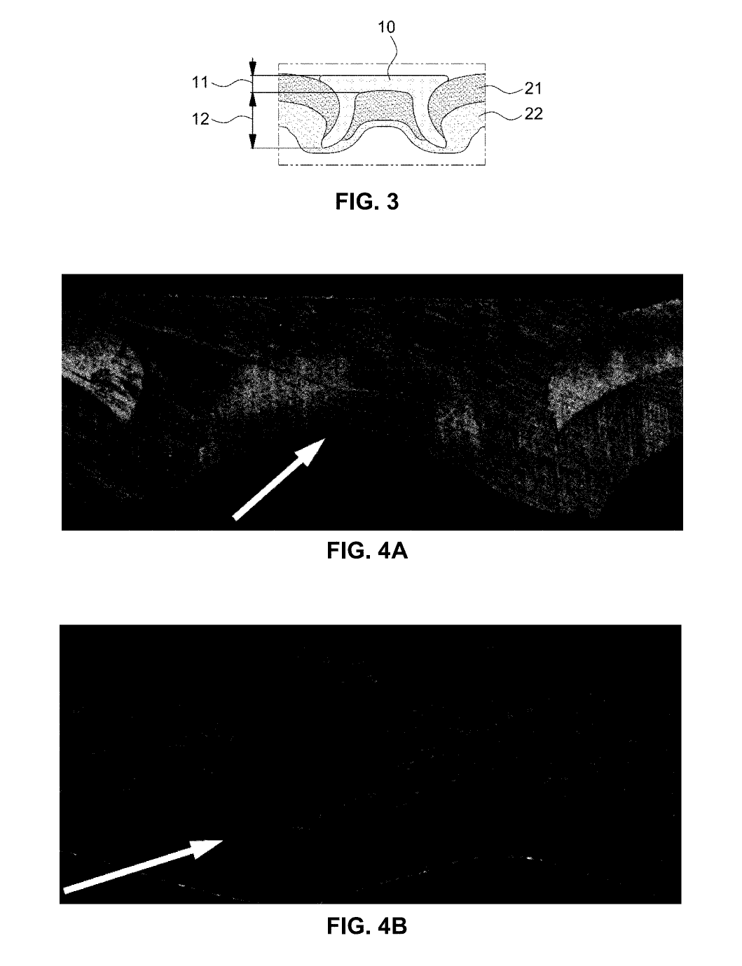

The connection member may be a self-piercing rivet. More particularly, a self-piercing rivet 10 may include a head portion 11 and a shank portion 12 as shown in FIG. 1. Further, after the shank portion 12 of the self-piercing rivet 10 passes through an upper plate 21 formed of a non-steel material by pressure applied by a punch 20 of a self-piercing rivet apparatus, the shank portion 12 is inserted into a lower plate 22 formed of ultra high-strength steel, is expanded outwardly due to an anvil die 23 and is thus fixed to the lower plate 22 as shown in FIG. 2, and, consequently, the upper plate 21 and the lower plate 22 are joined by the self-piercing rivet 10 as shown in FIG. 3.

A method of joining ultra high-strength steel and a non-steel material In accordance with various aspects of the present invention may include forming a tempering portion by performing heat treatment on a lower plate formed of the ultra high-strength steel using a laser, stacking an upper plate formed of the non-steel material on the lower plate formed of the ultra high-strength steel, disposing a connection member on the upper plate, and applying force to the connection member to cause the connection member to pass through the upper plate and then to be inserted into the tempering portion of the lower plate to combine the upper plate and the lower plate.

The present invention is technically characterized in that the lower plate formed of ultra high-strength steel is locally softened through heat treatment using a laser and is then joined with the upper plate using the connection member.

When the lower plate formed of ultra high-strength steel is joined with the upper plate using the connection member under the condition that the lower plate is not softened and fastening strength thereof is remarkably lowered. This will be apparently observed through FIGS. 4A and 4B.

FIG. 4A is a photograph illustrating the cross-section of a joining structure of an upper plate and ultra high-strength steel (a lower plate) having tensile strength of 980 MPa using a self-piercing rivet (SPR) under the condition that tailored softening heat treatment of the lower plate is not conducted. With reference to FIG. 4A, it may be observed that the lower plate is detached from the upper plate at a portion displayed by an arrow.

FIG. 4B is a photograph illustrating the cross-section of a joining structure of an upper plate and ultra high-strength steel (a lower plate) having tensile strength of 1470 MPa using a self-piercing rivet (SPR) under the condition that tailored softening heat treatment of the lower plate is not conducted. With reference to FIG. 4B, it may be observed that bucking of the rivet occurs at a portion displayed by an arrow.

To solve the above-described problems, the present invention is technically characterized in that a method of joining ultra high-strength steel and a non-steel material includes forming a tempering portion by performing heat treatment on a lower plate formed of ultra high-strength steel using a laser.

In more detail, heat treatment of the lower plate using a laser is conducted so that a maximum temperature reaches 400° C. or higher, particularly 450° C. to 550° C., and more particularly 500° C. or lower, thereby a tempering portion being formed.

To apply heat of the above-described temperature to the lower plate, a laser may be radiated under conditions (1) to (4) below.

(1) A laser generator output of 2.5 kW to 3.5 kW, particularly 2.5 kW to 3.0 kW, and more particularly 2.5 kW

(2) A laser generator set temperature of 400° C. to 600° C., particularly 430° C. to 500° C., and more particularly 450° C. to 470° C.

(3) A laser radiation time of less than 1 second

(4) A laser beam focal spot size of 8 mm to 20 mm, particularly 12 mm to 20 mm, and more particularly 17 mm.

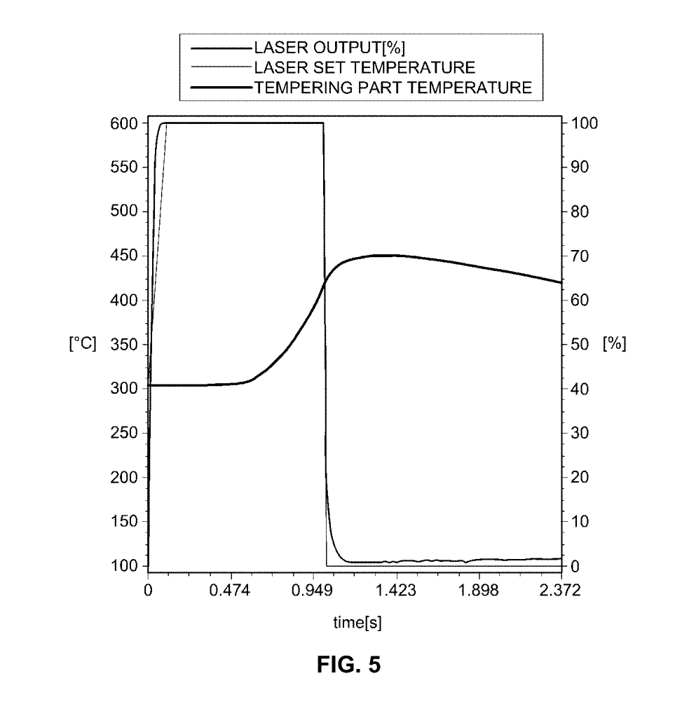

FIG. 5 is a graph illustrating a result of measurement of temperature (heat) applied to a tempering part, when a laser is radiated to ultra high-strength steel having tensile strength of 980 MPa. Here, a laser generator generates a laser under conditions of an output of 2.5 kW (100% output), a set (maximum) temperature of 600° C., a laser radiation time of less than 1 second, and a laser beam focal spot size of 17 mm. With reference to FIG. 5, it may be confirmed that a laser is radiated to ultra high-strength steel having tensile strength of 980 MPa under the above-described conditions and thus heat is applied to the ultra high-strength steel within a temperature range of 300° C. to 450° C., such that a maximum temperature reaches about 450° C.

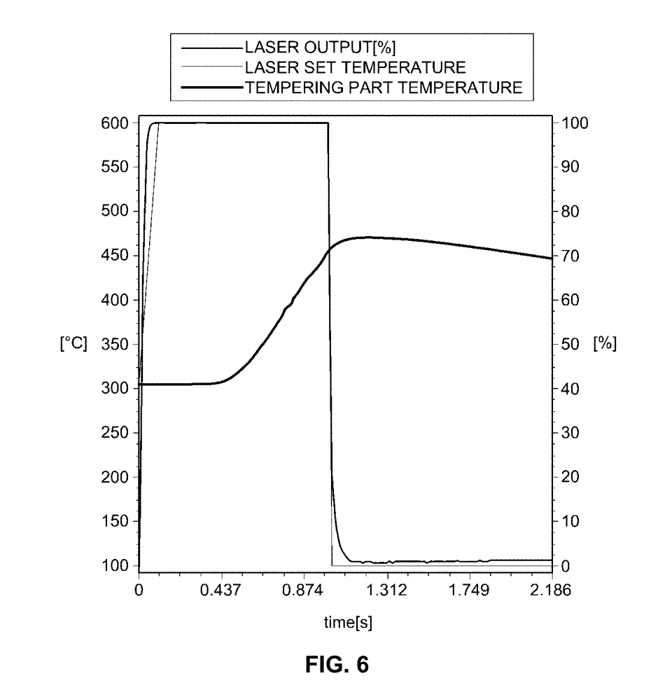

FIG. 6 is a graph illustrating a result of measurement of temperature (heat) applied to a tempering part, when a laser is radiated to ultra high-strength steel having tensile strength of 1180 MPa. Here, the laser generator generates a laser under conditions of an output of 2.5 kW (100% output), a set (maximum) temperature of 600° C., a laser radiation time of less than 1 second, and a laser beam focal spot size of 17 mm. With reference to FIG. 6, it may be confirmed that a laser is radiated to ultra high-strength steel having tensile strength of 1180 MPa under the above-described conditions and thus heat is applied to the ultra high-strength steel within a temperature range of 300° C. to 470° C. so that a maximum temperature reaches about 470° C.

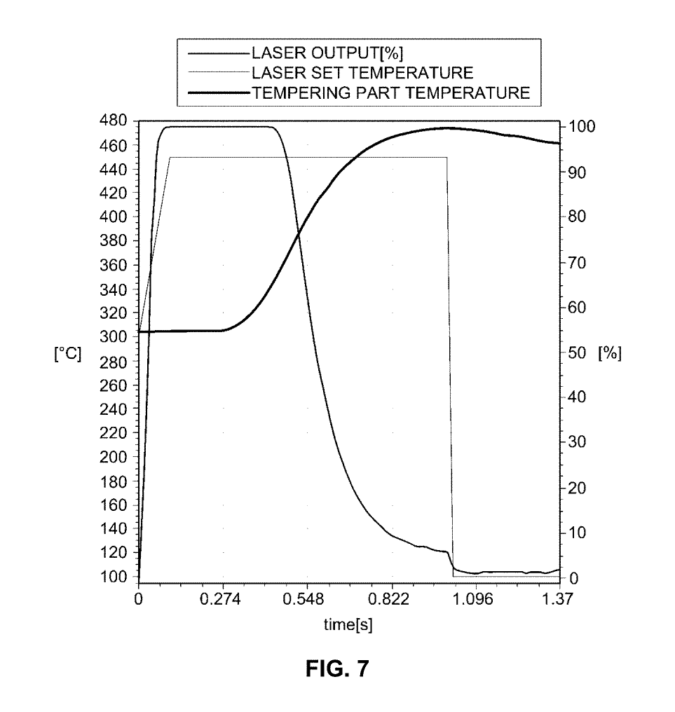

FIG. 7 is a graph illustrating a result of measurement of temperature (heat) applied to a tempering part, when a laser is radiated to ultra high-strength steel having tensile strength of 1470 MPa. Here, the laser generator generates a laser under conditions of an output of 2.5 kW (100% output), a set (maximum) temperature of 450° C., a laser radiation time of less than 1 second, and a laser beam focal spot size of 17 mm. With reference to FIG. 7, it may be confirmed that a laser is radiated to ultra high-strength steel having tensile strength of 1470 MPa under the above-described conditions and thus heat is applied to the ultra high-strength steel within a temperature range of 300° C. to 480° C. so that a maximum temperature reaches about 480° C.

As described above, the present invention is technically characterized in that a locally softened tempering portion is formed by performing heat treatment on a lower plate formed of ultra high-strength steel using a laser and thus a connection member is easily inserted into the tempering portion to increase fastening strength between upper and lower plates.

In heat treatment performed by radiating the laser to the lower plate formed of ultra high-strength steel, when the maximum temperature of heat treatment is lower than 400° C., the lower plate is not sufficiently softened and thus effects of heat treatment may be unsatisfactory and, when the maximum temperature of heat treatment is higher than 600° C., hardness of the lower plate may be raised due to crystallization.

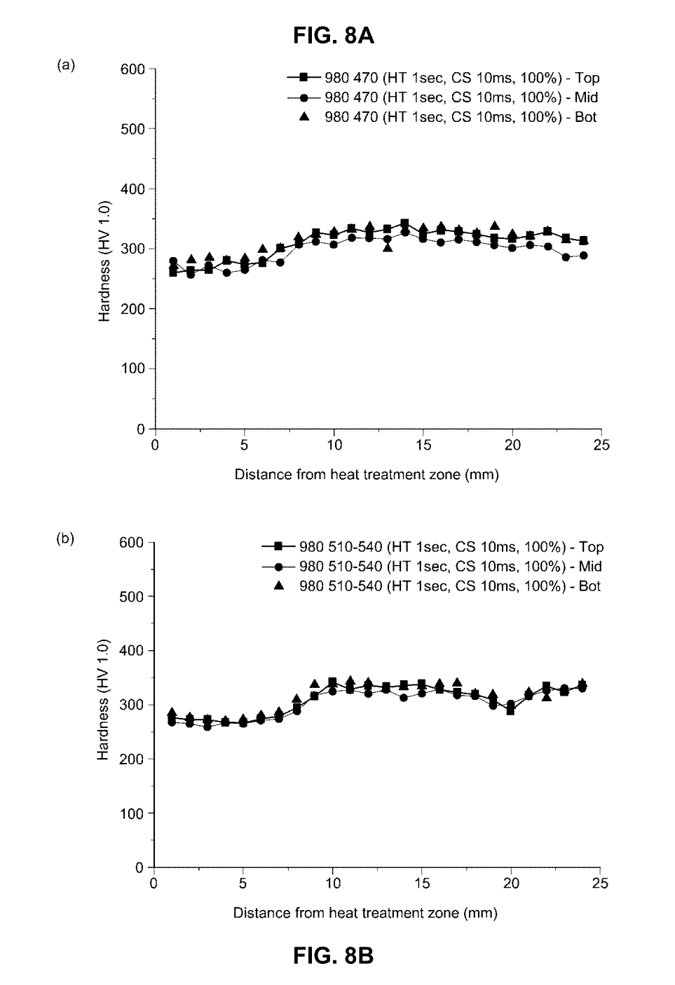

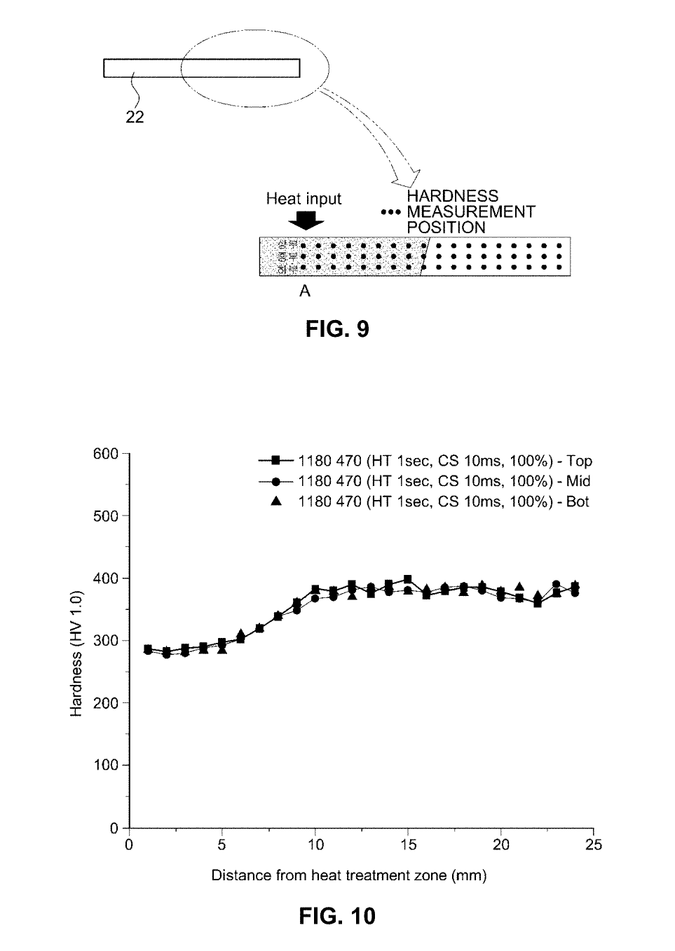

FIG. 8A and FIG. 8B are graphs illustrating a result of measurement of hardness when heat treatment using a laser (laser radiation) is conducted for about 1 second on ultra high-strength steel having tensile strength of 980 MPa. In more detail, as shown in FIG. 9, hardnesses of respective points of a lower plate 22, on which heat treatment has been finished, from a central portion A thereof for heat treatment to a portion thereof distanced from the central portion A by 25 mm in the rightward direction are measured.

Hardness of ultra high-strength steel having tensile strength of 980 MPa is about 338 HV. With reference to FIG. 8A, when heat treatment using a laser is conducted so that a maximum temperature reaches 470° C., hardnesses of points around the central portion A of the lower plate are measured as 270 HV to 300 HV and hardnesses of other respective points of the lower plate are measured as 270 HV to 340 HV, and thus, it may be confirmed that tailored softening is sufficiently achieved. Further, with reference to FIG. 8B, when heat treatment using a laser is conducted so that a maximum temperature reaches about 530° C., hardnesses of points around the central portion A of the lower plate are measured as 270 HV to 300 HV and hardnesses of other respective points of the lower plate are measured as 270 HV to 350 HV. and thus, it may be confirmed that tailored softening is sufficiently achieved.

FIG. 10 is a graph illustrating a result of measurement of hardness when heat treatment using a laser (laser radiation) is conducted for about 1 second on ultra high-strength steel having tensile strength of 1180 MPa. Hardness of ultra high-strength steel having tensile strength of 1180 MPa is about 400 HV. With reference to FIG. 10, when heat treatment using a laser is conducted so that a maximum temperature reaches 470° C., hardnesses of points around the central portion A of the lower plate for heat treatment are measured as 280 HV to 320 HV and hardnesses of other respective points of the lower plate are measured as 280 HV to 400 HV. and thus, it may be confirmed that tailored softening is sufficiently achieved.

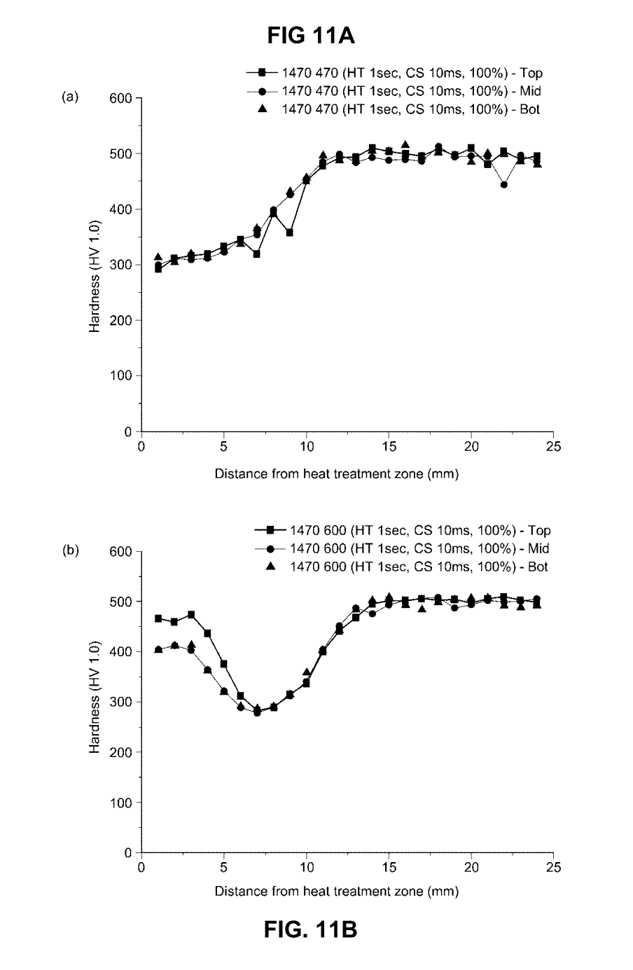

FIG. 11A and FIG. 11B are graphs illustrating a result of measurement of hardness when heat treatment using a laser (laser radiation) is conducted for about 1 second on ultra high-strength steel having tensile strength of 1470 MPa. Hardness of ultra high-strength steel having tensile strength of 1470 MPa is about 512 HV. With reference to FIG. 11A, when heat treatment using a laser is conducted so that a maximum temperature reaches 470° C., hardnesses of points around the central portion A of the lower plate for heat treatment are measured as 300 HV to 350 HV and hardnesses of other respective points of the lower plate are measured as 300 HV to 500 HV and, thus, it may be confirmed that tailored softening is sufficiently achieved. On the other hand, with reference to FIG. 11B, when heat treatment using a laser is conducted so that a maximum temperature reaches about 600° C., it is observed that hardnesses at points around the central portion A of the lower plate are rapidly increased and thus, the temperature of heat treatment is set to 550° C. or lower as described above.

Therefore, In accordance with various aspects of the present invention, a tempering portion of a lower plate is formed through heat treatment by radiating a laser under the above-described conditions and the tempering portion has hardness of 350 HV or lower, particularly 270 HV to 350 HV, and thus, a connection member may be easily inserted into the lower plate and fastening strength between upper and lower plates may be improved.

In accordance with various aspects of the present invention, the upper plate is stacked on the lower plate provided with the tempering portion and then the connection member is disposed on the upper plate. Here, as shown in FIG. 2, the connection member is disposed at a position of the upper plate, at which the connection member may be inserted into the tempering portion of the lower plate when force is subsequently applied to the connection member.

In accordance with various aspects of the present invention, after disposition of the connection member on the upper plate, force is applied to the connection member so that the connection member passes through the upper plate and is then inserted into the tempering portion of the lower plate, the upper plate and the lower plate being combined.

Hereinafter, the present invention will be described in more detail through detailed examples. The following examples illustrate the invention and are not intended to limit the same.

### Test Example 1

Steel having tensile strength of 980 MPa is used as a lower plate and aluminum A5056 is used as an upper plate. The thicknesses of the upper plate and the lower plate are respectively 1.2 mm.

A tempering portion of the lower plate is formed by performing heat treatment on the lower plate under conditions below.

A laser generator output of 2.5 kW (100% output)

A laser generator set (maximum) temperature of 600° C.

A laser radiation time of about 1 second

A laser beam focal spot size of 17 mm

A heat treatment temperature range of 300° C. to 470° C.

After the upper plate is stacked on the lower plate, a self-piercing rivet (SPR) is disposed on the upper plate, and force is applied to the SPR by a punch so that the SPR passes through the upper plate and is then inserted into the tempering portion of the lower plate, producing a joining structure of different materials.

### Test Example 2

An upper plate and a lower plate are combined using the same method as in test example 1 except that steel having tensile strength of 1180 MPa is used as the lower plate.

### Test Example 3

An upper plate and a lower plate are combined using the same method as in test example 1 except that steel having tensile strength of 1470 MPa is used as the lower plate.

### Comparative Example

Steel having tensile strength of 780 MPa is used as a lower plate and aluminum A5056 is used as an upper plate. The thicknesses of the upper plate and the lower plate are respectively 1.2 mm.

After the upper plate is stacked on the lower plate under the condition that no tempering portion of the lower plate is formed, a self-piercing rivet (SPR) is disposed on the upper plate, and force is applied to the SPR by a punch so that the SPR passes through the upper plate and is then inserted into the tempering portion of the lower plate, producing a joining structure of different materials.

Test 1

To evaluate elongations of the tempering parts of test example 1 to test example 3, a cupping test of the lower plates of test example 1 to test example 3 and comparative example is executed. Results of the test are stated in Table 1 below.

TABLE 1

| | Tensile | Max | Max punch |
|---|---|---|---|
| Division | strength | displacement | force |
| Comparative | 780 MPa | 3.3 mm | 16.2 kN |
| example | | | |
| Test example 1 | 980 MPa | 2.6 mm | 15.4 kN |
| Test example 2 | 1180 MPa | 2.2 mm | 16.6 kN |
| Test example 3 | 1470 MPa | 2.0 mm | 18.2 kN |

With reference to Table 1, the tempering parts of test example 1 to test example 3 exhibit similar results to steel having tensile strength of 780 MPa (of comparative example) other than ultra high-strength steel. In accordance with various aspects of the present invention, it may be confirmed that ultra high-strength steel and a non-steel material may be joined with sufficient joining strength using a self-piercing rivet (SPR)

Test 2

The cross-sections and appearances of the joining structures of different materials of test example 1 to test example 3 are evaluated.

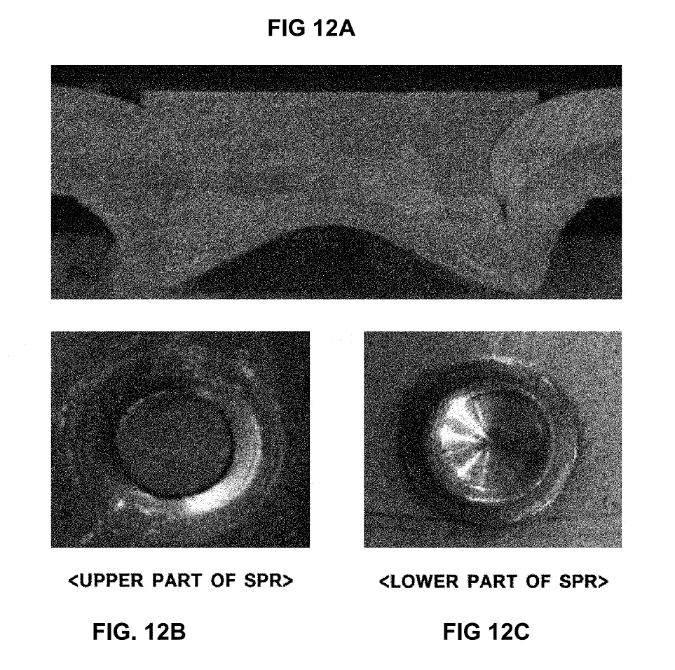

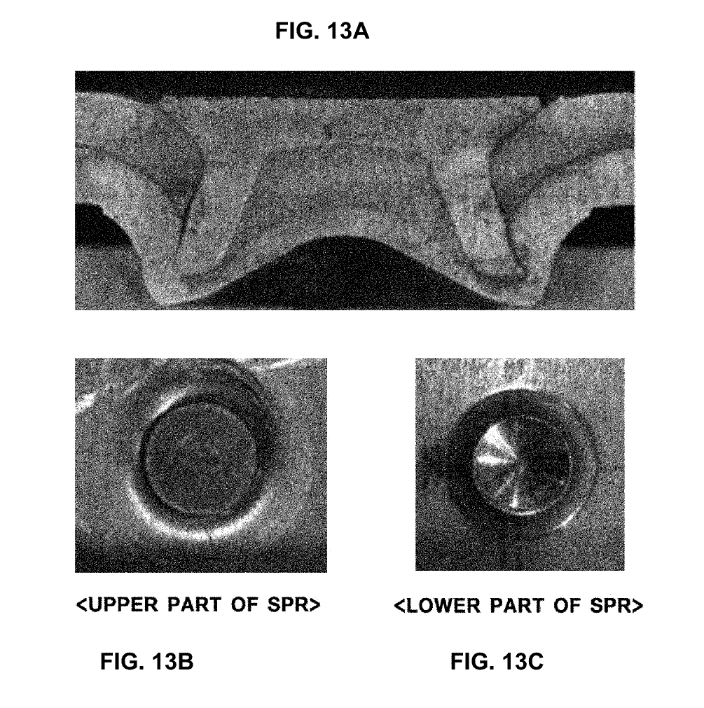

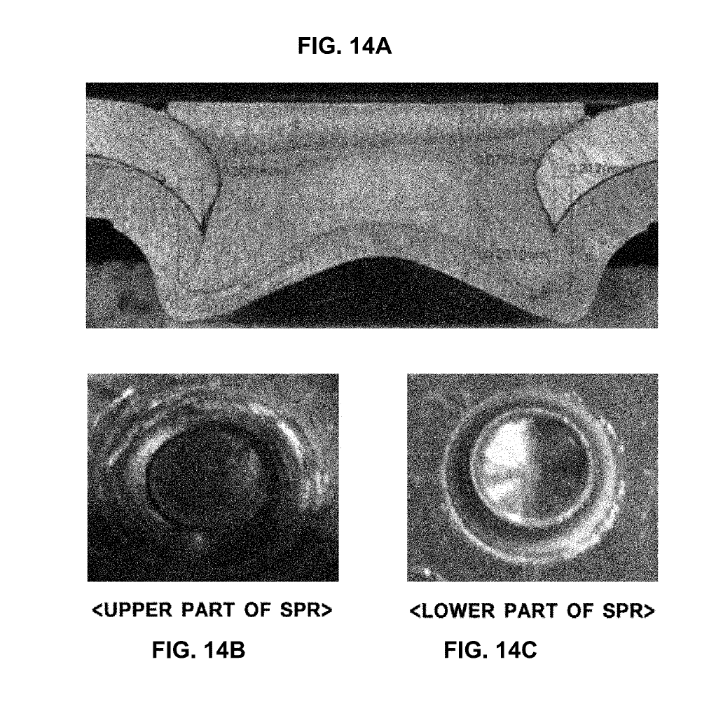

FIG. 12A, FIG. 12B and FIG. 12C are photographs of the cross-section and appearance of the joining structure of different materials of Test Example 1. FIG. 13A, FIG. 13B and FIG. 13C are photographs of the cross-section and appearance of the joining structure of different materials of Test Example 2. FIG. 14A, FIG. 14B and FIG. 14C are photographs of the cross-section and appearance of the joining structure of different materials of Test Example 3.

With reference to FIG. 12A, FIG. 13A and FIG. 14A, it may be confirmed that flaring of the self-piercing rivets is satisfactory and the thicknesses of the lower plates are 0.15 mm or more, and thus, joining quality is excellent.

With reference to FIG. 12B, FIG. 12C, FIG. 13B, FIG. 13C, FIG. 14B and FIG. 14C, it may be confirmed that the self-piercing rivets may satisfactorily join the upper plates and the lower plates without damage to the self-piercing rivets.

Test 3

Joining (shearing/tensile) strengths of the joining structures of different materials of test example 1 to test example 3 are evaluated. In more detail, maximum loads of the joining structures are measured through an axial tension method using a universal testing machine (UTM). Results of the test are stated in Table 2 below.

TABLE 2

| | Tensile strength of ultra | |
|---|---|---|
| Division | high-strength steel | Max load |
| Test example 1 | 980 MPa | 3,775 N-4,375 N |
| Test example 2 | 1180 MPa | 3,777 N-4,150 N |
| Test example 3 | 1470 MPa | 3,669 N-4,196 N |

With reference to Table 2, it may be confirmed that maximum loads of the joining structures of test example 1 to test example 3 are measured as more than 3,500 N and, thus, joining states of the joining structures are satisfactory.

As is apparent from the above description, a method of joining of a ultra high-strength steel and a non-steel material In accordance with various aspects of the present invention may have effects, as below.

In the joining method, in accordance with various aspects of the present invention, the ultra high-strength steel and the non-steel material may be joined using a self-piercing rivet without change of conventional equipment and design. Therefore, a joining structure of different materials having excellent quality may be provided without rise in costs and level of process difficulty.

Further, in the joining method in accordance with various aspects of the present invention, fastening force between the ultra high-strength steel and the non-steel material is secured through tailored softening using a laser for a short time and, thus, joining between the ultra high-strength steel and the non-steel material may be easily achieved. Therefore, the joining method In accordance with various aspects of the present invention may be applied to actual industrial settings.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the locations of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of joining of a ultra high-strength steel and a non-steel material through tailored softening heat treatment using a laser, the method including:
forming a tempering portion by performing heat treatment on a lower plate formed of the ultra high-strength steel using the laser;
stacking an upper plate formed of the non-steel material on the lower plate formed of the ultra high-strength steel;
disposing a connection member on the upper plate; and
applying force to the connection member to cause the connection member to pass through the upper plate and then to be inserted into the tempering portion of the lower plate to combine the upper plate and the lower plate.

2. The method of claim 1, wherein the ultra high-strength steel is steel having tensile strength of 980 MPa or more.

3. The method of claim 1, wherein the ultra high-strength steel is steel having tensile strength of 1180 MPa or more.

4. The method of claim 1, wherein the ultra high-strength steel is steel having tensile strength of 1470 MPa or more.

5. The method of claim 1, wherein the non-steel material is carbon fiber reinforced plastic (CFRP) or aluminum.

6. The method of claim 1, wherein the tempering portion is formed by performing the heat treatment on the lower plate using the laser so that a maximum temperature reaches 400° C. to 550° C.,
wherein the laser is radiated under conditions (1) to (4) below:
(1) a laser generator output of 2.5 kW to 3.5 kW;
(2) a laser generator set temperature of 400° C. to 600° C.;
(3) a laser radiation time of less than 1 second; and
(4) a laser beam focal spot size of 8 mm to 20 mm.

7. The method of claim 1, wherein hardness of the tempering portion is 270 HV to 350 HV.

8. The method of claim 1, wherein the connection member is a self-piercing rivet (SPR).
